(19) United States
(12) Patent Application Publication
(10) Pub. No.: US 2015/0003199 A1
(43) Pub. Date: Jan. 1, 2015

(54) METHODS AND APPARATUS FOR DETERMINING STIMULATED VOLUME OF OIL AND GAS RESERVOIRS

(71) Applicant: Bernard Widrow, Stanford, CA (US)

(72) Inventor: Bernard Widrow, Stanford, CA (US)

(21) Appl. No.: 14/375,088

(22) PCT Filed: Jan. 28, 2013
(86) PCT No.: PCT/US2013/023438

§ 371 Date: Jul. 28, 2014

Related U.S. Application Data
(60) Provisional application No. 61/591,246, filed on Jan. 26, 2012.

(51) Int. Cl. G01V 1/28; E21B 47/00

(52) U.S. Cl. CPC G01V 1/288; E21B 47/0003
USPC 367/25

(57) ABSTRACT

The invention relates to methods and apparatuses for a new signal processing method for substantial noise reduction with the goal of making small microquakes detectable and localizable, giving more data points and detail regarding fracking geometry. According to some aspects, the invention provides a fully integrated system including a novel self-focusing adaptive beamformer.

### FIELD OF THE INVENTION

The present invention relates to gathering acoustic data from sensors, and more particularly to methods and apparatuses for gathering passive seismic data to accurately map the extent of drainage volume and provide data used in the calculation of a reservoir's economic ultimate recovery.

### BACKGROUND OF THE INVENTION

More accurate fracture mapping in real-time (while pumping) will allow more efficient and safer fracking management by using less pumping, less water, less proppant, and less chemicals.

This will afford lower environmental impact and less cost.

It is generally possible to detect and localize large microquakes with signals from geophone arrays.

Small microquakes are much more numerous, but are often undetectable because of noise.

For the purpose of this invention, the term microquakes refers to microseismic events, small earthquakes, and passive seismic acoustic energy emissions.

### SUMMARY OF THE INVENTION

The invention relates to methods and apparatuses for a new signal processing method for substantial noise reduction with the goal of making small microquakes detectable and localizable, giving more data points and detail regarding fracking geometry.

According to some aspects, the invention provides a 10 dB to 20 dB or more reduction in noise power. Even with large microquakes, this should improve localization accuracy.

A substantial reduction in noise in real-time seismic monitoring of hydraulic fracturing will enable this process to be less costly, minimize the amount of pumping, and be more environmentally friendly.

Noise reduction will make possible the detection and localization of smaller and more numerous microquakes, giving a more detailed picture of frac geometry. Making this available while pumping will allow more efficient fracking management.

To reduce noise, we propose a novel self-focusing adaptive beamformer. This highly original design consists of a unique combination of proven technologies: adaptive equalization and adaptive beamforming.

The components of the self-focusing adaptive beamformer are the following:

Equalization: The self-focuser employs adaptive filters for equalization. Adaptive filters are now a standard technique in digital signal processing. Since we would not know beforehand the frequency response of the various seismic ray paths, adaptive equalization can compensate for this just as adaptive equalization is used in every computer modem to compensate for unpredictable variability in the frequency response of communication channels, whether wired, wireless, or fiber optic.

Adaptive beamforming: Adaptive beamformers, even when used with small arrays—as small as a half dozen geophones—are capable of yielding substantial noise reductions. Depending on the spatial distributions of the sources of noise, reductions of 10-50 dB have been experienced with small arrays. Greater noise reductions are achieved when the noise sources in the earth are more spatially concentrated. Adaptive beamformers have been used by the U.S. military for many years. They are now just beginning to be used in hearing aids, cell phone antennas, and other communication systems. The most widely used adaptive beamformer methods are disclosed in Frost¹, Griffiths-Jim², and Widrow-McCool³, the contents of which are incorporated herein by reference in their entirety. Experiments will be done with all three of these beamformers to determine the most practical technique for real time frac monitoring. ¹ FROST, III, O. L., “An Algorithm for Linearly Constrained Adaptive Array Processing,” Proceedings of the IEEE, vol. 60, pp 926-935, August 1972.² GRIFFITHS, L. J. and JIM, C., “An Alternative Approach to Linearly Constrained Beamforming,” IEEE Transactions on Antennas and Propagation, vol. AP-30, pp. 27-34, January 1982.³ WIDROW, B. and McCOOL, J. M., “A Comparison of Adaptive Algorithms Based on the Methods of Steepest Descent and Random Search,” IEEE Transactions on Antennas and Propagation, vol. AP-24, no. 5, pp. 615-637, September 1976.

### BRIEF DESCRIPTION OF THE DRAWINGS

These and other aspects and features of the present invention will become apparent to those ordinarily skilled in the art upon review of the following description of specific embodiments of the invention in conjunction with the accompanying figure, wherein:

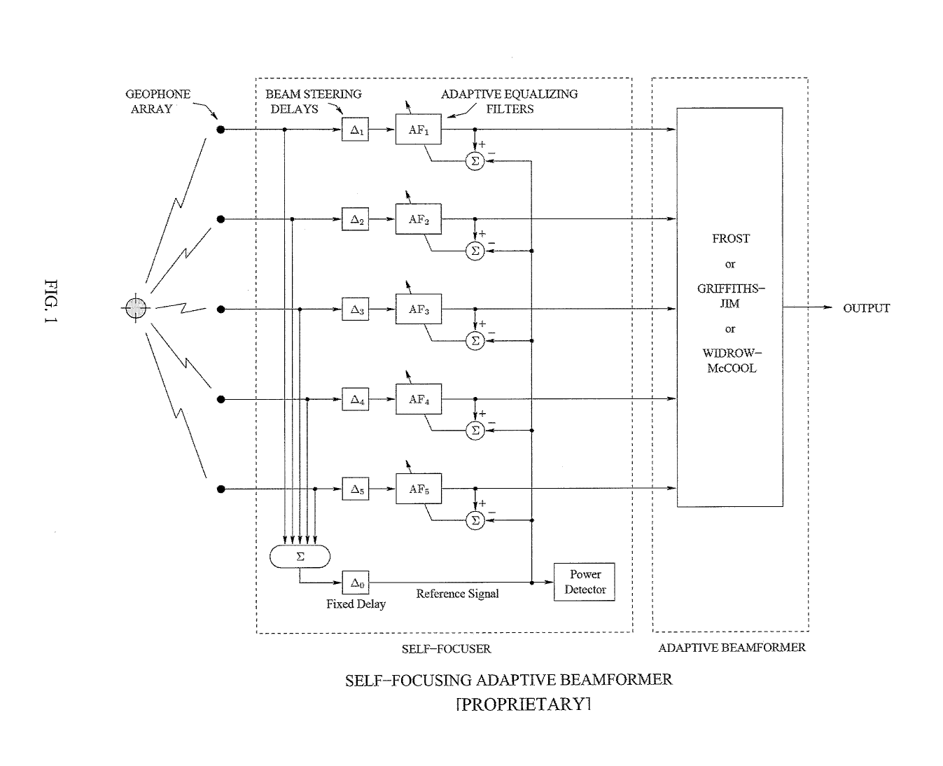

The attached FIG. 1 depicts various aspects of the invention.

### DETAILED DESCRIPTION OF THE PREFERRED EMBODIMENTS

The present invention will now be described in detail with reference to the drawings, which are provided as illustrative examples of the invention so as to enable those skilled in the art to practice the invention. Notably, the figures and examples below are not meant to limit the scope of the present invention to a single embodiment, but other embodiments are possible by way of interchange of some or all of the described or illustrated elements. Moreover, where certain elements of the present invention can be partially or fully implemented using known components, only those portions of such known components that are necessary for an understanding of the present invention will be described, and detailed descriptions of other portions of such known components will be omitted so as not to obscure the invention. Embodiments described as being implemented in software should not be limited thereto, but can include embodiments implemented in hardware, or combinations of software and hardware, and vice-versa, as will be apparent to those skilled in the art, unless otherwise specified herein. In the present specification, an embodiment showing a singular component should not be considered limiting; rather, the invention is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The idea for a self-focusing adaptive beamformer is diagrammed in the attached FIG. 1. It consists of a self-focusing preprocessor followed by a conventional adaptive beamformer.

The idea is derived from adaptive optics used in large telescopes with multiple deformable mirrors. Self-focusing allows one to correct for ray path distortions caused by the Earth's atmosphere. Focusing on a bright star by deforming the mirrors to receive maximum brightness, beam steering in azimuth and elevation in the vicinity of the bright star allows one to detect otherwise undetectable faint stars that are nearby in angle of arrival.

The proposed system applies this concept to in-the-earth imaging but, in addition, utilizes an adaptive beamformer for noise reduction. The self-focuser can focus on a large microquake and, once focused, can supply signals to the adaptive beamformer that arrive from volumes of earth in the vicinity of the origin of the large microquake. These volumes can be scanned in azimuth and elevation by making small changes in the beam steering delays, taking into account the array geometry and the velocity along the ray paths.

The proposed beamformer can be used for P-waves and S-waves, and separately for the three axes of geophones in a three-axis array. Range can be estimated from the difference in arrival times of P- and S-waves, and in addition, multiple arrays can be used to triangulate and localize large and small microquakes.

Focusing is done by adjusting the beam steering delays and the adaptive filters to maximize the signal power of the selected large microquake. The weights of the adaptive beamformer are trained after self-focusing is done, by replaying the seismic data through the self-focuser and inputting this to the adaptive beamformer. The weights of the adaptive beamformer converge to provide a constrained fixed gain for seismic signals emanating from the volume of earth where the selected microquake originated (the “look” volume), while minimizing the total noise arriving from all other volumes of earth. The location of the look volumes can be scanned by altering the beam steering delays. Outputs from the self-focusing adaptive beamformer are representative of seismic signals emanating from the look volume and will be used to detect and localize small microquakes.

Although the present invention has been particularly described with reference to the preferred embodiments thereof, it should be readily apparent to those of ordinary skill in the art that changes and modifications in the form and details may be made without departing from the spirit and scope of the invention. It is intended that the appended claims encompass such changes and modifications.

What is claimed is:

1. A method for mapping small microquakes when pumping a hydraulic fracture comprising:
(a) receiving signals from an array of seismic sensors,
(b) processing the seismic sensor signals and feeding the processed signals to an adaptive beamformer, and
(c) using an adaptive beamformer of either the Frost, Griffiths-Jim, or Widrow-McCool type, lowering the noise floor and whose output is seismic signals representative of microquake events.

2. An apparatus for mapping small microquakes when pumping a hydraulic fracture comprising:
(a) signal inputs from an array of seismic sensors,
(b) a self-focusing pre-processor for processing the seismic sensor signals and for feeding the processed signals to an adaptive beamformer, and
(c) an adaptive beamformer of either the Frost, Griffiths-Jim, or Widrow-McCool type for lowering the noise floor and whose output is seismic signals representative of microquake events.
